(19) United States
(12) Patent Application Publication
(10) Pub. No.: US 2007/0121084 A1
(43) Pub. Date: May 31, 2007

(54) PROJECTOR WITH A PLURALITY OF LIGHT SOURCES

(76) Inventor: Chong-Min Chang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/563,683

(22) Filed: Nov. 28, 2006

(30) Foreign Application Priority Data
Nov. 28, 2005 (TW) 094141723

(51) Int. Cl. G03B 21/26

(52) U.S. Cl. 353/94

(57) ABSTRACT

A projector includes a housing, a first light source installed inside the housing for generating light beams, a second light source installed inside the housing for generating light beams, a first refractive element installed inside the housing for refracting the light beams generated by the first light source, a second refractive element installed inside the housing for refracting the light beams generated by the second light source to a direction parallel to a direction of the light beams refracted by the first refractive element substantially, a light pipe installed inside the housing for uniformizing light beams from the first refractive element and the second refractive element, and an image device installed inside the housing for processing the uniformized light from the light pipe and for projecting the processed light to form an image.

### BACKGROUND OF THE INVENTION

1. Field of the Invention

The present invention relates to a projector, and more particularly, to a projector with a plurality of light sources.

2. Description of the Prior Art

With the progress of optics, projectors have found broad use in many applications. Generally speaking, projected light intensity is usually an important factor while designing a projector, as the projection quality improves with greater intensity of the projected light.

Please refer to FIG. 1 . FIG. 1 is a schematic diagram of a projector 10 in the prior art. The projector 10 includes a light source 12, a color wheel 14, a light pipe 16, and an image device 18. The light source 12 is used to generate a light beam 22 and to project the light beam 22 through the color wheel 14 to the light pipe 16. The color wheel 14 is positioned between the light source 12 and the light pipe 16. The color wheel 14 rotates round an axle 15 and outputs red, green, and blue polarized beams 24 by turning after filtering the light beam 22 via different filters so that the image device 18 can process the input beams according to their specific color. The light pipe 16 uniformizes the beams 24 to output a uniformized beam 26 to the image device 18. The image device 18 processes the uniformized beam 26 to modulate an image into the uniformized beam 26 to form an image beam 28. The image beam 28 is projected to a screen 20 to form a projection image. The light source 12 is composed of a bulb 30 for generating light and a lampshade 32 for collecting the light generated by the bulb 30 to form the light beam 22.

Because the projector 10 includes only one bulb 30 as a lighting device to provide light to the projector 10, the power of the bulb 30 should be raised when enhancing the brightness of the projection image of the projector 10. However, this method of enhancing the brightness of the projection image of the projector 10 is improper. For example, when the power of the bulb 30 is raised, the waste heat of the bulb 30 increases correspondingly, increasing the operational temperature of the projector 10. Further, if the bulb 30 becomes too hot, the bulb 30 could burn out.

### SUMMARY OF THE INVENTION

It is therefore a primary objective of the claimed invention to provide a projector with a plurality of light sources for solving the above-mentioned problem.

According to the claimed invention, a projector includes a housing, a first light source installed inside the housing for generating light beams, a second light source installed inside the housing for generating light beams, a first refractive element installed inside the housing for refracting the light beams generated by the first light source, a second refractive element installed inside the housing for refracting the light beams generated by the second light source to a direction parallel to a direction of the light beams refracted by the first refractive element substantially, a light pipe installed inside the housing for uniformizing light beams from the first refractive element and the second refractive element, and an image device installed inside the housing for processing the uniformized light from the light pipe and for projecting the processed light to form an image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a projector in the prior art.

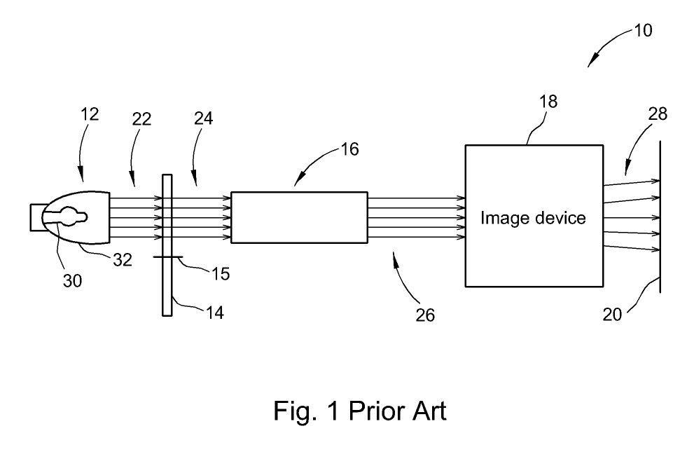

FIG. 2 is a schematic diagram of a projector of a first embodiment according to the present invention.

FIG. 3 is a schematic diagram of a projector of a second embodiment according to the present invention.

### DETAILED DESCRIPTION

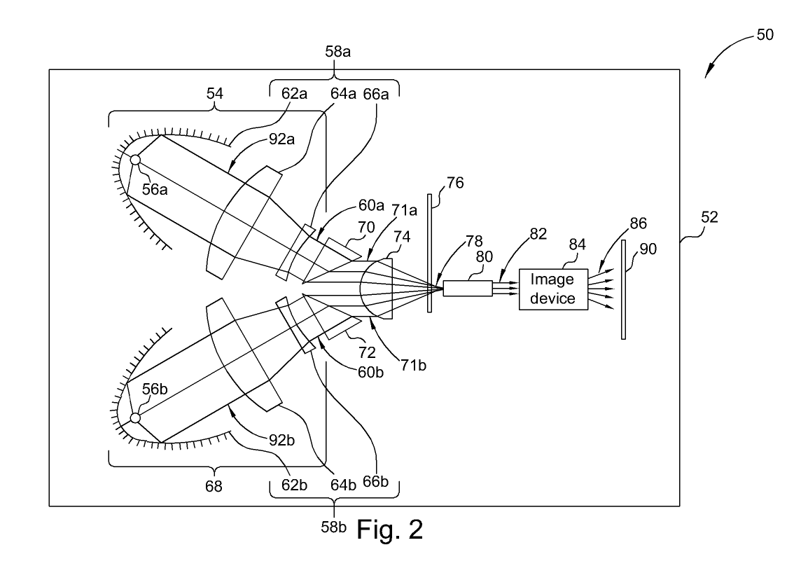

Please refer to FIG. 2. FIG. 2 is a schematic diagram of a projector 50 of a first embodiment according to the present invention. The projector 50 includes a housing 52, and a first light source 54 installed inside the housing 52. The first light source 54 includes a light device 56a for generating light and a light collector 58a for collecting the light generated by the light device 56a to form a light beam 60a. The light collector 58a includes a parabolic mirror 62a. The light device 56a is positioned on a focus of the parabolic mirror 62a. The light collector 58a further includes a positive lens 64a and a negative lens 66a. The projector 50 further includes a second light source 68 installed inside the housing 52 and on a side opposite to the first light source 54. The second light source 68 includes a light device 56b for generating light and a light collector 58b for collecting the light generated by the light device 56b to form a light beam 60b. The light collector 58b includes a parabolic mirror 62b. The light device 56b is positioned on a focus of the parabolic mirror 62b. The light collector 58b further includes a positive lens 64b and a negative lens 66b. Each of the light device 56a and the light device 56b can be a bulb. Each of the positive lens 64a and the positive lens 64b can be a plano-convex lens or a biconvex lens. Each of the negative lens 66a and the negative lens 66b can be a plano-concave lens or a biconcave lens. The projector 50 further includes a first refractive element 70 and a second refractive element 72. The first refractive element 70 and the second refractive element 72 can be prisms for refracting the light beam 60a and the light beam 60b so as to form condensed beams 71a, 71b. The first refractive element 70 and the second refractive element 72 are not connected.

The projector 50 further includes a focusing lens assembly 74 for focusing the condensed beams 71a, 71b from the first refractive element 70 and the second refractive element 72, and a color wheel 76 for filtering a light beam 78 via different filters to output red, green, and blue beams by turning. The focusing lens assembly 74 focuses the light beam 78 to an entrance of a light pipe 80. The light pipe 80 can uniformize the light beam 78 to output a uniformized beam 82. The projector 50 further includes an image device 84 for processing the uniformized beam 82 to modulate an image into the uniformized beam 82 to form an image beam 86. The image beam 86 is projected to a screen 90 to form a projection image.

The optical paths of the light from the first light source 54 and the second light source 68 to the screen 90 are described in detail as follows. First the light devices 56a, 56b are positioned on the focuses of the parabolic mirrors 62a, 62b respectively, so the light emitted from the light devices 56a, 56b is reflected as two parallel beams 92a, 92b by the parabolic mirrors 62a, 62b. The positive lenses 64a, 64b can refract and condense the parallel beams 92a, 92b, and then the negative lenses 66a, 66b can refract the light refracted by the positive lenses 64a, 64b as the light beams 60a, 60b. That is, the combination of the positive lenses 64a, 64b and the negative lenses 66a, 66b can condense light so that the light can be condensed to emit to the first refractive element 70 and the second refractive element 72. Then the first refractive element 70 and the second refractive element 72 deflect the light beams 60a, 60b to form the condensed beams 71a, 71b. The focusing lens assembly 74 focuses the condensed beams 71a, 71b to form the light beam 78. The color wheel 76 filters the light beam 78 via different filters to output red, green, and blue beams by turning. The focusing lens assembly 74 focuses the light beam 78 to the entrance of the light pipe 80. The light pipe 80 uniformizes the light beam 78 to output the uniformized beam 82. At last the image device 84 processes the uniformized beam 82 to modulate an image into the uniformized beam 82 to form the image beam 86. The image beam 86 is projected to the screen 90 to form a projection image.

The first refractive element 70 and the second refractive element 72 can change the optical paths of the light generated by the first light source 54 and the second light source 68 so as to condense the light emitted from the first light source 54 and the second light source 68. The light from the light source can be condensed to output to the lens of the projector 50 so as to enhance the brightness and uniformity of the projection image of the projector 50. In addition, the distance between the first light source 54 and the second light source 68 can be increased so as to prevent the concentrated heat generated by the light device 56a, 56b because the first refractive element 70 and the second refractive element 72 can focus the light emitted from the first light source 54 and the second light source 68 to the focusing lens assembly 74.

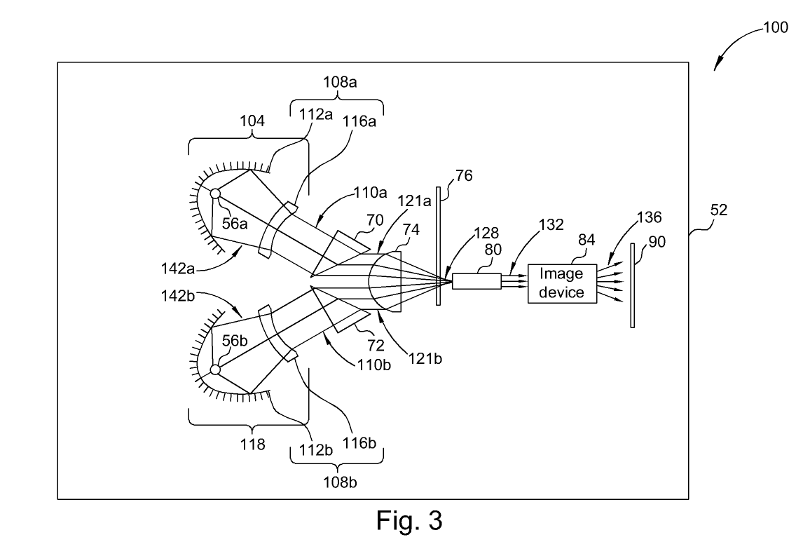

Please refer to FIG. 3. FIG. 3 is a schematic diagram of a projector 100 of a second embodiment according to the present invention. The difference between the projector 50 and the projector 100 is the light collector. The projector 100 includes a first light source 104. The first light source 104 includes the light device 56a for generating light and a light collector 108a for collecting the light generated by the light device 56a to form a light beam 110a. The light collector 108a includes an ellipsoid mirror 112a. The light device 56a is positioned on a focus of the ellipsoid mirror 112a. The light collector 108a further includes a negative lens 116a. The projector 100 further includes a second light source 118 installed on a side opposite to the first light source 104. The second light source 118 includes a light device 56b for generating light and a light collector 108b for collecting the light generated by the light device 56b to form a light beam 110b. The light collector 108b includes an ellipsoid mirror 112b. The light device 56b is positioned on a focus of the ellipsoid mirror 112b. The light collector 108b further includes a negative lens 116b. Each of the light device 56a and the light device 56b can be a bulb. Each of the negative lens 116a and the negative lens 116b can be a plano-concave lens or a biconcave lens. The projector 100 further includes the first refractive element 70 and the second refractive element 72. The first refractive element 70 and the second refractive element 72 can be prisms for refracting the light beam 110a and the light beam 110b so as to form condensed beams 121a, 121b. The focusing lens assembly 74 of the projector 100 can focus the condensed beams 121a, 121b. The color wheel 76 filters a light beam 128 via different filters to output red, green, and blue beams by turning. The focusing lens assembly 74 focuses the light beam 128 to an entrance of the light pipe 80. The light pipe 80 can uniformize the light beam 128 to output a uniformized beam 132. The image device 84 processes the uniformized beam 132 to modulate an image into the uniformized beam 132 to form an image beam 136. The image beam 136 is projected to the screen 90 to form a projection image.

The light devices 56a, 56b are positioned on the focuses of the ellipsoid mirrors 112a, 112b respectively, so the light emitted from the light devices 56a, 56b is reflected as two condensed beams 142a, 142b by the ellipsoid mirrors 112a, 112b. The negative lenses 116a, 116b can refract the condensed beams 142a, 142b as the light beams 110a, 110b. That is, the combination of the ellipsoid mirrors 112a, 112b and the negative lenses 116a, 116b can condense and parallelize light so that the light can be condensed to emit to the first refractive element 70 and the second refractive element 72. Then the first refractive element 70 and the second refractive element 72 deflect the light beams 110a, 110b to form the condensed beams 121a, 121b. The focusing lens assembly 74 focuses the condensed beams 121a, 121b to form the light beam 128. The color wheel 76 filters the light beam 128 via different filters to output red, green, and blue beams by turning. The focusing lens assembly 74 focuses the light beam 128 to the entrance of the light pipe 80. The light pipe 80 uniformizes the light beam 128 to output the uniformized beam 132. At last the image device 84 processes the uniformized beam 132 to modulate an image into the uniformized beam 132 to form the image beam 136. The image beam 136 is projected to the screen 90 to form a projection image.

In contrast to the conventional projector with one light device, the projector according to the present invention includes a plurality of light sources so as to enhance the brightness of the projection image. In addition, the refractive elements can condense the light generated by the light sources to form a condensed beam so as to concentrate the light to output to the lens of the projector, increasing light efficiency and uniformity of the light sources. In addition, the distance between the light sources can be increased so as to prevent the concentrated heat generated by the light sources.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projector comprising:
a housing;
a first light source installed inside the housing for generating light beams; a second light source installed inside the housing for generating light beams;
a first refractive element installed inside the housing for refracting the light beams generated by the first light source;
a second refractive element installed inside the housing for refracting the light beams generated by the second light source to a direction parallel to a direction of the light beams refracted by the first refractive element substantially;
a light pipe installed inside the housing for uniformizing light beams from the first refractive element and the second refractive element; and
an image device installed inside the housing for processing the uniformized light from the light pipe and for projecting the processed light to form an image.

2. The projector of claim 1 wherein each of the first light source and the second light source comprises a light device for generating light and a light collector for collecting the light generated by the light device to form the light beam.

3. The projector of claim 2 wherein the light device is a bulb.

4. The projector of claim 2 wherein the light collector comprises:
a parabolic mirror, the light device being positioned on a focus of the parabolic mirror;
a positive lens installed between the light device and the first refractive element or the second refractive element; and
a negative lens installed between the positive lens and the first refractive element or the second refractive element.

5. The projector of claim 4 wherein the positive lens is a plano-convex lens.

6. The projector of claim 4 wherein the positive lens is a biconvex lens.

7. The projector of claim 4 wherein the negative lens is a plano-concave lens.

8. The projector of claim 4 wherein the negative lens is a biconcave lens.

9. The projector of claim 2 wherein the light collector comprises:
a ellipsoid mirror, the light device being positioned on a focus of the ellipsoid mirror; and
a negative lens installed between the light device and the first refractive element or the second refractive element.

10. The projector of claim 9 wherein the negative lens is a plano-concave lens.

11. The projector of claim 9 wherein the negative lens is a biconcave lens.

12. The projector of claim 1 further comprising a focusing lens assembly for focusing light beams from the first refractive element and the second refractive element.

13. The projector of claim 12 further comprising a color wheel installed between the focusing lens assembly and the light pipe for filtering the focused light beam so as to output beams with different colors by turning.

14. The projector of claim 1 wherein each of the first refractive element and the second refractive element is a prism.

15. The projector of claim 1 wherein the first refractive element and the second refractive element are not connected.
